(19) United States
(12) Patent Application Publication
(10) Pub. No.: US 2014/0379447 A1
(43) Pub. Date: Dec. 25, 2014

(54) METHOD AND APPARATUS FOR STREAMLINED OFFER PROCESSING

(71) Applicant: ITI Group, LLC, Akron, OH (US)

(72) Inventors: Christopher M. Thompson, Nokomis, FL (US); Shawn G. Inks, Richfield, OH (US)

(73) Assignee: ITI Group, LLC, Akron, OH (US)

(21) Appl. No.: 14/294,194

(22) Filed: Jun. 3, 2014

Related U.S. Application Data
(60) Provisional application No. 61/839,128, filed on Jun. 25, 2013.

(51) Int. Cl. G06Q 30/02

(52) U.S. Cl. CPC G06Q 30/0215; G06Q 30/0234
USPC 705/14.17

(57) ABSTRACT

This disclosure is of a system and method for using transaction cards to provide discounts to customers, where the customer initially funds the discount and then obtains a refund of the discount either simultaneously or shortly after the transaction.

### I. BACKGROUND

A. Field

This invention pertains to the art of electronic discounts, and more specifically, to methods and apparatuses for providing electronic discounts using transaction cards.

B. Description of the Related Art

It is known in the art to have a system and method to provide rewards or loyalty incentives to card member customers. Such a system includes an enrolled card member customer database, an enrolled merchant database, a participating merchant offer database and a registered card processor. The enrolled card member customer database includes transaction accounts of card member customers enrolled in a loyalty incentive program. The enrolled merchant database includes a list of merchants participating in the loyalty incentive program. The participating merchant offer database includes loyalty incentive offers from participating merchants. The registered card processor receives a record for charge for a purchase made with an enrolled merchant by an enrolled card member customer and uses the record of charge to determine whether the purchase qualifies for a rebate credit in accordance with a discount offer from the enrolled merchant. If the purchase qualifies for a rebate credit, the registered card processor provides the rebate credit to an account of the enrolled card member customer. The system provides a coupon-less way for merchants to provide incentive discounts to enrolled customers. Such a system is described in U.S. Patent Publication 2008/0021772 to Aloni et al., published on Jan. 24, 2008, entitled LOYALTY INCENTIVE PROGRAM USING TRANSACTION CARDS, which is incorporated herein by reference.

It is known for merchants to offer coupons or discounts for the merchants' goods or services, or for goods sold by the merchant but manufactured by another manufacturer. It is also known to provide customers with transaction cards that the customers can use to obtain discounts without the need to exchange physical coupons. Such a transaction card may be a credit card, a debit card, or a prepaid card. Because of the many point-of-sale systems used by merchants, it would be cumbersome and inefficient to try to integrate a discount system using transaction cards with each point-of-sale system. Also, entering and verifying custom coupons by merchant staff can be complex and difficult. For this reason, a centralized processor is used to implement a discount system using transaction cards.

To use a centralized processor, it is also known to have the merchant fund the discount by putting funding in a holding account equal to the amount of anticipated redemptions. For example, if the merchant offers a $25-off discount from a purchase of $50 and anticipates 10,000 customers will receive this offer, the merchant places $250,000 in a holding account. When a customer uses such a transaction card to use the $25-off discount on a $50 purchase and also pay for the purchase, $25 is debited from the customer's transaction card account and $25 is debited from the merchant's holding account.

What is needed, however, is an electronic discount system that does not require the merchant to fund a holding account to make discounts available. The present invention addresses this need.

### II. SUMMARY

In accordance with one aspect of the present invention, a system for providing discounts to a customer includes a processor computer including a central processing unit, memory, a storage medium, and a communication interface, wherein the processor computer is programmed to: a. store discounts from at least one merchant in an electronic discount database; b. electronically receive information from a card terminal about a transaction card and a purchase transaction; c. compare the information received against eligible discounts in the discount database; d. electronically transfer from a card account that is linked to the transaction card into a merchant account purchase funds equal to a purchase price of the purchase transaction without any discount; and e. if the purchase transaction qualifies for a discount, electronically transfer from the merchant account into the card account discount funds equal to the discount.

In accordance with another aspect of the present invention, a method for providing discounts to a customer includes the steps of: a. providing the customer with a transaction card that is linked to a card account; b. providing a merchant with a card terminal programmed to obtain information about the transaction card and to transmit such information; c. providing a processor computer; d. providing a merchant account; e. the merchant transferring to a servicer details about discounts that the merchant wants to offer; f. the servicer storing the details about discounts on the processor computer; g. the customer initiating a purchase transaction with the merchant; h. the merchant obtaining information about the transaction card with the card terminal; i. the card terminal sending information about the purchase transaction and the transaction card to the processor computer; j. the processor computer analyzing the information sent from the card terminal and comparing the analyzed information with the details about discounts stored in the processor computer to determine if the purchase transaction qualifies for a discount; k. transferring from the card account to the merchant account purchase funds equal to a purchase price of the purchase transaction without any discount; and l. if the purchase transaction qualifies for a discount, transferring from the merchant account to the card account discount funds equal to the discount.

In accordance with yet another aspect of the present invention, a method for providing discounts to a customer includes the steps of: a. providing the customer with a transaction card that is linked to a card account with a first financial institution; b. providing a merchant with a card terminal programmed to obtain information about the transaction card and to transmit such information; c. providing a processor computer; d. providing a payment gateway including a merchant settlement account; e. providing a second financial institution including a merchant operating account; f. the merchant transferring to a servicer details about discounts that the merchant wants to offer; g. the servicer storing the details about discounts on the processor computer; h. the customer initiating a purchase transaction with the merchant; i. the merchant obtaining information about the transaction card with the card terminal; j. the card terminal electronically sending information about the purchase transaction and the transaction card to the payment gateway, which electronically routes the information to the processor computer; k. the processor computer analyzing the information sent from the card terminal and comparing the analyzed information with the details about discounts stored in the processor computer to determine if the purchase transaction qualifies for a discount; 1. prompting the customer through the card terminal as to 1) the portion of a purchase price of the purchase transaction that the customer wishes to pay using the transaction card, and 2) the portion of the purchase price of the purchase transaction that the customer wishes to pay using another payment method; m. checking electronically whether the card account contains sufficient funds to cover the portion of the purchase price that the customer wishes to pay using the transaction card; n. if the card account contains sufficient funds per step m): 1) electronically transferring from the card account to the merchant settlement account purchase funds equal to the portion of the purchase price that the customer wishes to pay using the transaction card; and 2) the customer paying the portion of the purchase price of the purchase transaction that the customer wishes to pay using another payment method; o. if the card account does not contain sufficient funds per step m), the customer paying the purchase price of the purchase transaction using another payment method; p. if the purchase transaction qualifies for a discount, electronically transferring from the merchant operating account to the card account discount funds equal to the discount; q. if the purchase transaction qualifies for the discount, the processor computer electronically notifying the customer about the discount; and r. electronically settling the merchant settlement account and the merchant operating account with each other.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a block diagram of one system embodiment of this invention.

FIG. 2 is a diagram of one process embodiment of this invention.

FIG. 3 is a diagram of the computer hardware.

FIG. 4 is a block diagram of another system embodiment of this invention.

FIG. 5 is a block diagram of another system embodiment of this invention.

### IV. DETAILED DESCRIPTION

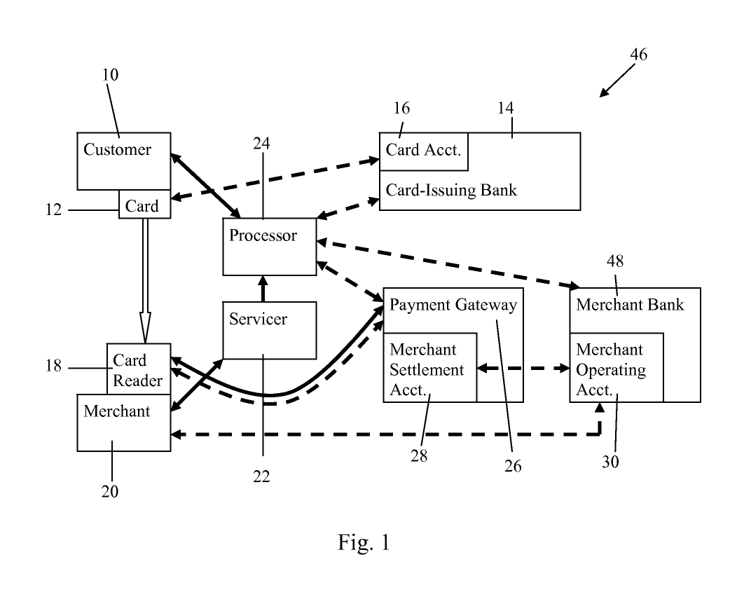

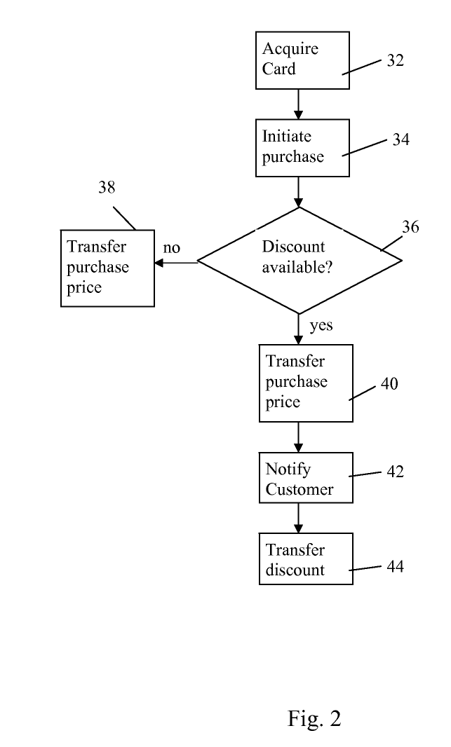

Referring now to the drawings wherein the showings are for purposes of illustrating embodiments of the invention only and not for purposes of limiting the same, and wherein like reference numerals are understood to refer to like components, FIG. 1 shows a block diagram of a system 46 according to one embodiment of this invention. A Customer 10 may use this system 46 to receive discounts at certain Merchants 20. The solid arrow lines show the transfer of information about the discounts, while the dashed arrow lines show the transfer of funds or information relating to the fund transfers. FIG. 2 shows a diagram of a process according to one embodiment of this invention. The system 46 is described with reference to these figures. Setting up such a system 46 may require approval of the below-described participating parties. In alternative embodiments, any of the below-described participating parties may also perform the functions of another below-described participating party or parties, thus rendering internal what may have been external communications.

Initially, at step 32, a Customer 10 may obtain a discount Card 12 or transaction Card 12. This Card 12 may be, in alternative embodiments, a prepaid card, a credit card, or a debit card. In another embodiment, the Card 12 may be a virtual card 12 that resides on a mobile device of a Customer 10. A prepaid card will be used for the rest of this description. The Card 12 may be linked to a Card Account 16 at a Card-Issuing Bank 14 or other financial institution, which may hold the funds that are prepaid. The Customer 10 may fund the Card Account 16 by means such as, but not limited to, depositing the Customer's 10 payroll into the Card Account 16; making a deposit to the Card Account 16 through a bank; or using the Card 12 as described below to obtain discounts. The Card Account 16 does not need to be with a bank, and it 16 may be any account representing a right to payment of a monetary obligation (e.g., a funds account). In another embodiment, the Card 12 may be other than a physical object and may be a means of identifying, linking to, or accessing the Card Account 16, such as an account number with an optional access code.

This Card 12 may be used to provide discounts to the Customer 10. A Merchant 20 may enroll with a Servicer 22 to have the Servicer 22 arrange for discounts to be available to Customers 10 through the use of transaction Cards 12. In alternative embodiments, the Servicer 22 may issue its own Cards 12 or may implement this system 46 using existing Cards 12. The Merchant 20 may decide on the terms of the discount the Merchant 20 wants to provide, and the Merchant may communicate this information to the Servicer 22. Terms may include, but are not limited to, the dates and/or times the discount will be valid, the amount of the discount, if any minimum purchase is required, and any limitation of the discount to particular goods or services. The Servicer 22 may transfer this information to a Processor 24, which may store this information in a database. The Processor 24 may be used as a hub of the system 46, as will be described below. The Processor 24 may also be known as the Back-End Processor 24 or the Card Program Processor 24. More than one Merchant 20 may make discounts available to Customers 10 using the same or different Cards 12. More than one Processor 24 may be used. In one embodiment, the Servicer 22 may create a portal, which may be an Internet-website-based portal, to allow the Merchant 20 to create, define, and manage discounts. In other embodiments, any other electronic communication protocol or method may be used to allow the Merchant 20 to create, define, and manage discounts.

In one embodiment, the Card-Issuing Bank 14 may issue the Card 12 to the Customer 10. In another embodiment, the Merchant may issue the Card 12 to the Customer 10. In another embodiment, the Servicer 22 may issue the Card 12 to the Customer 10. The Customer 10 may request to participate in the discount card program from any entity (Merchant 20, Servicer 22, Card-Issuing Bank 14, Merchant Bank 48) that offers entry into the program, even if another entity issues the actual Card 12.

The Merchant 20 may also decide to receive payments by transaction Cards 12, whether credit, debit, or prepaid. In such a case, the Merchant 20 may arrange with a Payment Gateway 26 to have the Payment Gateway 26 process payments to the Merchant 20 by transaction Cards 12. The Payment Gateway 26 may also be known as the Merchant Card Processor 26, the Acquiring Processor 26, the Acquiring Platform 26, the Front End Processor 26, or the Electronic Merchant Systems (EMS) Processor 26. In another embodiment, the Payment Gateway 26 may be a bank or another financial institution. The Merchant 20 may have a Card Reader 18 or card terminal 18 at the point of sale to obtain information about the transaction Card 12 for payment purposes. In an alternative embodiment, the Merchant 20 may also have a payment portal, which may be an Internet website portal, which is set up so that the Customer 10, or another party with the Customer's 10 authorization, may enter the Card 12 information into the portal to have the Customer 10 pay the Merchant 20.

When payment by the Card 12 to the Merchant 20 is made, the Payment Gateway 26 may, through the Processor 24, transfer funds from the Card Account 16 to the Merchant Settlement Account 28. Typically, all card transactions for a Merchant 20 for one day may be placed in this Merchant Settlement Account 28. All of the purchases from that Merchant 20 using transaction cards that day may be netted against all of the refunds by the Merchant 20 to transaction cards that day, with the resulting net amount in the Merchant Settlement Account 28 settled at the end of the day and moved to the Merchant's Operating Account 30, less any service charges. If the daily net amount in the Merchant Settlement Account 30 is negative, the net amount may be moved from the Merchant's Operating Account 30, including any service charges.

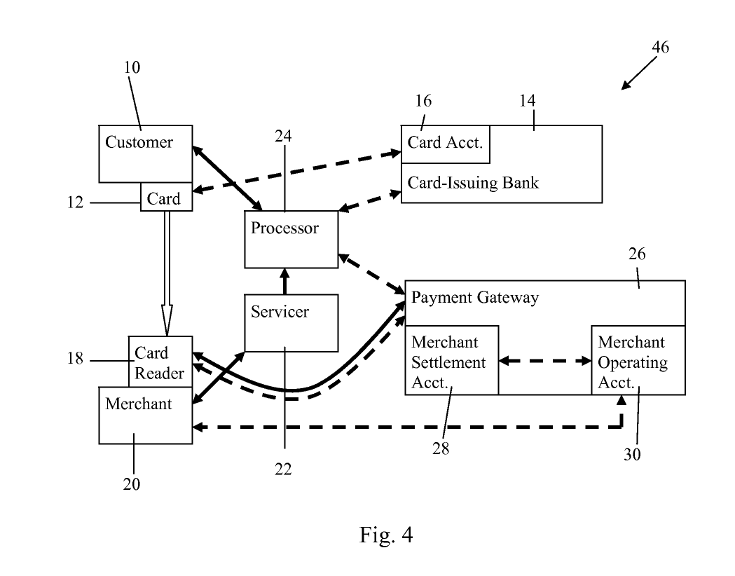

The Merchant's Operating Account 30 may be a regular business bank account that the Merchant 20 has with a Merchant Bank 48 or another financial institution. The Merchant 20 may use the Merchant Operating Account 30 for regular business, including depositing and withdrawing funds. This settlement process may also be used with the discount process shown in FIG. 2 and described below. In an alternative embodiment, the Merchant Bank 48 may also be (but does not have to be) the Payment Gateway 26, as shown in FIG. 4, such that the Merchant Operating Account 30 may be with the Payment Gateway 26. In yet another alternative embodiment, the Merchant Bank 48, Card-Issuing Bank 14, and Payment Gateway 26 may all be the same entity, such that the Card Account 16, Merchant Settlement Account 28, and Merchant Operating Account 30 are all held at the same entity. Each separate Merchant 20 may use its own Payment Gateway 26 and Merchant Bank 48, which may be the same as or different from those of other Merchants 20.

At step 34, the purchase transaction may be initiated. The Customer 10 may wish to buy property or services from a Merchant 20. Once the Customer 10 is ready to pay the Merchant 20, the Customer 10 may have the Card 12 swiped at the Merchant's 20 Card Reader 18. In alternative embodiments, the Card Reader 18 may read information from the Card 12 using any known methods, including, but not limited to: optical recognition; magnetic, electric, or electromagnetic communication; and radio-frequency communication. The Card Reader 18 may then transfer information about the Card 12 to the Payment Gateway 26. In an alternative embodiment, the Customer 10 or another party with the Customer's 10 authorization may enter the Card 12 information manually into an portal, which may be an Internet website portal, that is set up to accept payments from customers 10 to the Merchant 20, and the portal may then send the information about the Card 12 to the Payment Gateway 26. By using this system and method, the Merchant 20 does not need to fund the discount because the Customer 10 may fund it.

At step 36, the Payment Gateway 26 may communicate with the Processor 24 to determine how payment by the Card 12 is to be processed. The Bank Identification Number (BIN) on the Card 12 may direct the Payment Gateway 26 to communicate with the Processor 24. If multiple Processors 24 are used, the BIN on the Card 12 may direct the Payment Gateway 26 to the appropriate Processor 24. The Processor 24 may compare the information received about the Card 12 against a database of available discounts to see if the Card 12 is eligible for any discounts from that Merchant 20, including whether the purchase qualifies for the discount. If there are no discounts available at that time, the Processor 24 may, at step 38, direct the Card-Issuing Bank 14 to transfer the full purchase price from the Card Account 16 to that Merchant's Settlement Account 28, either directly or through the Processor 24. The Card-Issuing Bank 14 may reduce the balance in the Card Account 16 by the purchase price and transfer the purchase price amount less any service charges for itself to the Merchant Settlement Account 28 (push). In an alternative embodiment, the Processor 24 may direct the Payment Gateway 26, instead of the Card-Issuing Bank 14, to debit the full purchase price from the Card Account 16 and transfer the amount less any service charges to the Merchant Settlement Account 28, either directly or through the Processor 24 (pull). In another embodiment, the Card-Issuing Bank 14 may be the same as the Payment Gateway 26, in which case the appropriate amount may be moved from the Card Account 16 to the Merchant Settlement Account 28 internally.

If the Processor 24 determines, at step 36, that a discount is available, the Processor 24 may, at step 40, direct the Card-Issuing Bank 14 to transfer the full purchase price from the Card Account 16 to that Merchant's Settlement Account 28, just like in step 38. The Card-Issuing Bank 14 may reduce the balance in the Card Account 16 by the purchase price and transfer the purchase price amount less any service charges to the Merchant Settlement Account 28. The Merchant Settlement Account 28 may be settled with the Merchant Operating Account 30 as usual, as described above. The Processor 24 may then, at step 42, notify the Customer 10 of the discount and inform the Customer 10 that the discount amount will be refunded to the Customer's Card Account 16. In alternative embodiments, this notification can be accomplished using email, text messaging, instant messaging, multimedia messaging, an automated phone call, or other means of electronic communication. In an alternative embodiment, this notification may be accomplished at the point of sale using the Card Reader 18 with information received from the Payment Gateway 26.

The Processor 24 may then, at step 44, cause the Merchant Operating Account 30 (which has or shortly will settle with the Merchant Settlement Account 28 and thus receive the purchase funds) to be debited by the discount amount and any service fees, and cause these funds to be transferred from the Merchant Operating Account 30 to the Card Account 16 (whether by having the Merchant Bank 48 push the appropriate amount to the Card-Issuing Bank 14 directly or through the Processor 24, or, alternatively, by having the Card-Issuing Bank 14 pull the appropriate amount from the Merchant Bank 48 directly or through the Processor 24). Thus, there may be crossing pending transactions: a deposit and a withdrawal. In one embodiment, the discount may be refunded back to the Card Account 16 within 24-48 hours of the transaction. In one embodiment, the notification to the Customer 10 per step 42 may happen after the refund has occurred.

In another embodiment, the discount may be withdrawn before settlement from the Merchant Settlement Account 28 instead of the Merchant Operating Account 30. The Processor 24 may, at step 44, cause the Merchant Settlement Account 28 (that the Bank 14 just transferred funds to) to be debited by the discount amount and any service fees, and cause these funds to be transferred from the Merchant Settlement Account 28 to the Card Account 16 (whether by having the Payment Gateway 28 push the appropriate amount to the Card-Issuing Bank 14 directly or through the Processor 24, or, alternatively, by having the Card-Issuing Bank 14 pull the appropriate amount from the Payment Gateway 26 directly or through the Processor 24). In one embodiment, this debit of the discount may occur immediately after the transfer of step 40. In another embodiment, the Merchant Settlement Account 28 and the Merchant Operating Account 30 may be merged into one merchant account to which the Payment Gateway 26 and the Merchant Bank 48 both have access (or the two 26, 48 are one entity), where separate settlement is not necessary.

In an alternative embodiment, once the Processor 24 determines that a discount is available, at step 36, the system 46 may prompt the Customer 10, through the Payment Gateway 26 and Card Reader 18, to decide whether to use the discount for that purchase or to save it for later. If the Customer 10 chooses to use the discount, the system functions as described above beginning with step 40. If the Customer 10 declines to use the discount, the system functions as described above in step 38. In either embodiment (where the system 46 automatically applies the discount, or where the system 46 asks the Customer 10 whether to apply the discount), the Customer 10 does not need to know that a discount is available to take advantage of the discount; the Customer 10 will be notified and either will automatically get the discount (per the first embodiment) or will get to choose whether to use the discount (per the second embodiment).

The discount discussed may be viewed by the Customer 10 as a rebate or as a cash-back program, where the customer will receive the discount amount back onto the Card Account 16. In another embodiment, the Card 12 may be linked to a Card Account 16 that is a savings account, which earns interest on the funds in the card. In one embodiment, the Customer 10 may withdraw the funds that have accumulated in the Card Account 16.

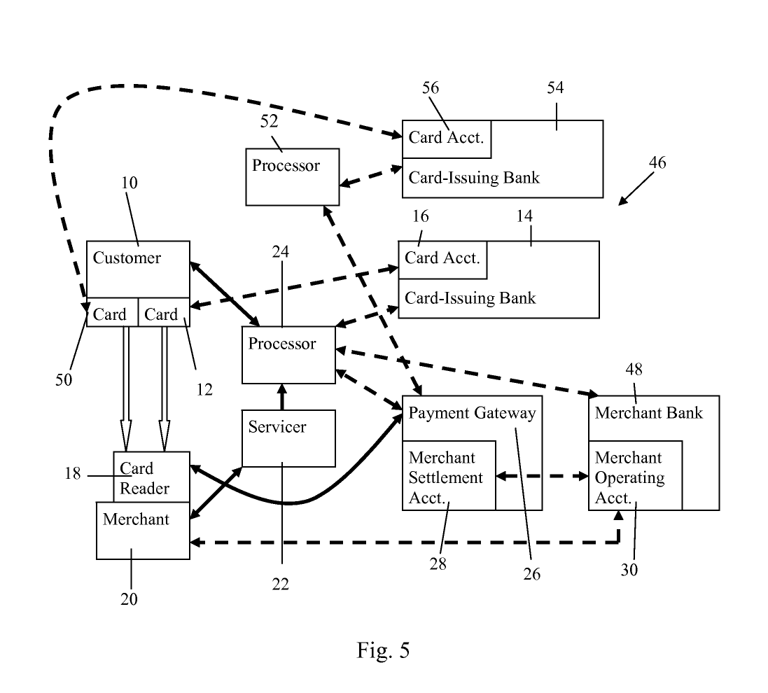

In another embodiment, the system 46 may allow the Customer 10 to use the Card 12 to obtain a discount for a purchase but use a different transaction card 50 to pay for the purchase, as shown in FIG. 5. For example, a Customer 10 may not have enough funds available in the Card Account 16 associated with the discount Card 12 and may need to pay by a different transaction card 50. The Customer 10 may direct the Merchant 20 to use a different transaction card 50 either initially or after the Payment Gateway 26 returns a message that there are insufficient funds in the Card Account 16. In such a case, the full purchase amount may be collected from the different transaction card 50 by the Merchant 20 using the Payment Gateway 26 and deposited in the Merchant Settlement Account 28, as in step 40. To do so, the Payment Gateway 26 may also communicate with a different processor 52 (analogous to the Processor 24) that handles the particular transaction card 50 used by the Customer 10, and this different processor 52 may communicate with the bank 54 or financial institution (analogous to the Card-Issuing Bank 14) that issued the transaction card 50. The Processor 24 may notify the Customer 10 that the discount will be refunded to the Customer's Card Account 16, as in step 42. The Processor 24 may then direct either the Card-Issuing Bank 14 or Merchant Bank 48 to transfer the discount amount from the Merchant Operating Account 30 to the Card Account 16 either directly or through the Processor 24. In another embodiment, the discount amount may be withdrawn before settlement from the Merchant Settlement Account 28 instead of the Merchant Operating Account 30. In such embodiments, the full price may be charged to the different transaction card 50 but the discount may be refunded to the discount Card 12.

In another embodiment, the Processor 24 may notify the Customer 10 that the discount will be refunded to the Customer's other transaction card 50. The Processor 24 may then direct the Merchant Bank 48 (or Payment Gateway 26) to transfer the discount amount from the Merchant Operating Account 30 (or Merchant Settlement Account 28) to the account 56 of the other transaction card 50 either directly, through the Processor 24, or through the different processor 52 (due to complexity, arrows representing these transfers are not shown on FIG. 5). In such an embodiment, the full price may be charged to the different transaction card 50 and the discount may be refunded to that transaction card 50. In another embodiment, the Processor 24 may ask the Customer 10, either at the point of sale through the Payment Gateway 26 and Card Reader 18 or afterwards through any communication means, whether the Customer 10 desires to receive the discount on the Card 12 or on the different transaction card 50 used to pay for the purchase.

In an alternative embodiment, the system 46 may allow split-tender if the Customer 10 requests to pay a portion of the purchase price with the Card 12 and a portion with a different transaction card 50 or other payment means. The system 46 may determine how much funds are in the Card Account 16, withdraw these funds to the Merchant Settlement Account 28 as described previously, and prompt the Customer 10 to tender the difference by another means of payment, which may be a different transaction card 50, cash, or check.

In one embodiment, the Customer 10 does not pay any service fees for using the Card 12. The Servicer 22 may receive a service fee from the Merchant Settlement Account 28 or the Merchant Operating Account 30 for each transaction where a Servicer-serviced discount is used. In another embodiment, the Merchant 20 may pay the Servicer 22 a monthly subscription fee to use the system 46.

In yet another embodiment, the Merchant 20 may sell goods provided by a Manufacturer who is not the Merchant 20, or services provided by a Provider who is not the Merchant 20; the following discussion will discuss the Manufacturer, but the analogous discussion applies for the Provider. In such cases, either the Merchant 20 or the Manufacturer may decide to provide a discount to the Customer 10. If the Manufacturer provides the discount, the system 46 may operate as described above. The Merchant 20 may later invoice the Manufacturer for the discount amount. If the Merchant 20 provides the discount, the Merchant 20 may fund the discount and transfers the funds to the Manufacturer; alternatively, the Manufacturer may later invoice the Merchant 20 for the discount amount.

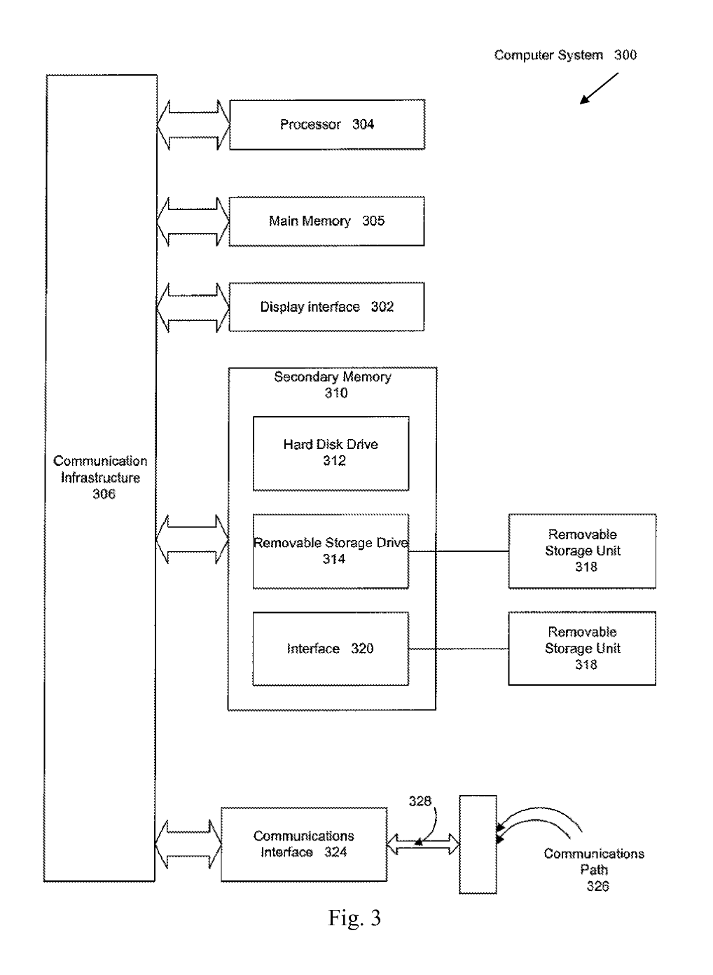

The present invention or any part(s) or function(s) thereof may be implemented using hardware, software, or a combination thereof, and may be implemented in one or more computer systems or other processing systems. In one embodiment, one or more computer systems is capable of carrying out the functionality described herein. An example of a computer system 300 is shown in FIG. 3.

With reference to FIG. 3, the computer system 300 may include one or more processors, such as processor 304. The processor 304 may be connected to a communication infrastructure 306 (e.g., a communications bus, cross-over bar, or network). Various software embodiments are described in terms of this exemplary computer system 300. After reading this description, it will become apparent to a person skilled in the relevant art(s) how to implement the invention using other computer systems and/or architectures.

Computer system 300 may include a display interface 302 that forwards graphics, text, and other data from the communication infrastructure 306 (or from a frame buffer not shown) for display on the display unit 330.

Computer system 300 also may include a main memory 305, which may be random access memory (RAM), and may also include a secondary memory 310. The secondary memory 310 may include, for example, a hard disk drive 312 and/or a removable storage drive 314, representing a floppy disk drive, a magnetic tape drive, an optical disk drive, etc. The removable storage drive 314 may read from and/or write to a removable storage unit 318 in a well known manner. Removable storage unit 318 may represent a floppy disk, magnetic tape, optical disk, etc. which may be read by and written to by removable storage drive 314. As will be appreciated, the removable storage unit 318 may include a computer usable storage medium having stored therein computer software and/or data.

In alternative embodiments, secondary memory 310 may include other similar devices for allowing computer programs or other instructions to be loaded into computer system 300. Such devices may include, for example, a removable storage unit 318 and an interface 320. Examples of such may include a program cartridge and cartridge interface (such as that found in video game devices), a removable memory chip (such as an erasable programmable read only memory (EPROM), or programmable read only memory (PROM)) and associated socket, and other removable storage units 318 and interfaces 320, which allow software and data to be transferred from the removable storage unit 318 to computer system 300.

Computer system 300 may also include a communications interface 324. Communications interface 324 may allow software and data to be transferred between computer system 300 and external devices. Examples of communications interface 324 may include a modem, a network interface (such as an Ethernet card), a communications port, a Personal Computer Memory Card International Association (PCMCIA) slot and card, etc. Software and data transferred via communications interface 324 are in the form of signals 328 which may be electronic, electromagnetic, optical or other signals capable of being received by communications interface 324. These signals 328 may be provided to communications interface 324 via a communications path (e.g., channel) 326. This channel 326 may carry signals 328 and may be implemented using wire or cable, fiber optics, a telephone line, a cellular link, a radio frequency (RF) link and other communications channels.

Computer programs (also referred to as computer control logic) may be stored in main memory 305 and/or secondary memory 310. Computer programs may also be received via communications interface 324. Such computer programs, when executed, may enable the computer system 300 to perform the features of the present invention, as discussed herein. In particular, the computer programs, when executed, may enable the processor 304 to perform the features of the present invention. Accordingly, such computer programs may represent controllers of the computer system 300.

In an embodiment where the invention is implemented using software, the software may be stored in a computer program product and loaded into computer system 300 using removable storage drive 314, hard drive 312 or communications interface 324. The control logic (software), when executed by the processor 304, may cause the processor 304 to perform the functions of the invention as described herein. In another embodiment, the invention may be implemented primarily in hardware using, for example, hardware components such as application specific integrated circuits (ASICs). Implementation of the hardware state machine so as to perform the functions described herein will be apparent to persons skilled in the relevant art(s). In yet another embodiment, the invention may be implemented using a combination of both hardware and software.

In one embodiment, the various parties 22, 24, 14, 18, 26, 48 of the system 46 may each include a computer executing an application programming interface (API) that allows communication with other parties of the system 46. In one embodiment, the Servicer 22 may include an API that communicates with the Processor's 24 API, the Merchant Bank's 48 API, and the Card-Issuing Bank's 14 API. The Servicer's 22 API may facilitate automation of the above-described process. The Servicer's 22 API may include a back-end interface and a front-end user interface or control panel that manages information flow. In one embodiment, the Servicer's 22 API may accept information from any of the Processor's 24 API, the Merchant Bank's 48 API, and the Card-Issuing Bank's 14 API and deliver information to any of the Processor's 24 API, the Merchant Bank's 48 API, and the Card-Issuing Bank's 14 API.

The present invention may be implemented using existing platforms and payment rails, such as those maintained by Visa®, MasterCard®, Discover®, and American Express®, and others. The Card Reader 18, Processor 24, and Payment Gateway 26 may communicate using such payment rails, as also may the Card-Issuing Bank 14 and the Merchant Bank 48. In alternative embodiments, the Card 12 may be branded to operate on any of the mentioned platforms, and thus the funds rebated to the Card Account 16 because of the discounts may be used anywhere where the branded Card 12 is accepted.

Numerous embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

I/we claim:

1. A system for providing discounts to a customer, comprising:
a processor computer comprising a central processing unit, memory, a storage medium, and a communication interface, wherein the processor computer is programmed to:
a. store discounts from at least one merchant in an electronic discount database;
b. electronically receive information from a card terminal about a transaction card and a purchase transaction;
c. compare the information received against eligible discounts in the discount database;
d. electronically transfer from a card account that is linked to the transaction card into a merchant account purchase funds equal to a purchase price of the purchase transaction without any discount; and
e. if the purchase transaction qualifies for a discount, electronically transfer from the merchant account into the card account discount funds equal to the discount.

2. The system of claim 1, further comprising:
a card account;
a transaction card linked to the card account;
a card terminal programmed to obtain information about the transaction card and to transmit such information; and
a merchant account.

3. The system of claim 2 wherein:
the merchant account comprises a merchant settlement account and a merchant operating account that are settled with each other;
the transfer of purchase funds from the card account is into the merchant settlement account; and
the transfer of discount funds into the card account is from the merchant operating account.

4. The system of claim 3 wherein if the purchase transaction qualifies for the discount the processor computer is further programmed to electronically send a notification to the customer that the discount will be refunded to the card account.

5. The system of claim 3 wherein if the purchase transaction qualifies for the discount the processor computer is further programmed to:
transfer the purchase funds and the discount funds within 48 hours of the purchase transaction; and
electronically send a notification to the customer within 48 hours of the purchase transaction that the discount was refunded to the card account.

6. The system of claim 3 wherein if the purchase transaction qualifies for the discount the processor computer is further programmed to:
prompt the customer through the card terminal whether the customer wishes to use the discount; and
transfer the discount funds only if the customer indicates through the card terminal a wish to use the discount.

7. The system of claim 3 further comprising:
a first financial institution comprising:
the card account; and
a first financial institution computer programmed to communicate with the processor computer;
a second financial institution comprising:
the merchant operating account; and
a second financial institution computer programmed to communicate with the processor computer; and
a payment gateway comprising:
the merchant settlement account; and
a payment gateway computer programmed to:
a. communicate with and send information between the processor computer and the card terminal; and
b. communicate with the second financial institution computer to settle the merchant operating account with the merchant settlement account.

8. The system of claim 7 wherein:
the transaction card is an electromagnetic or optical card; and
the card reader is electromagnetic or optical.

9. The system of claim 8 wherein the transaction card is a member selected from the group consisting of:
a credit card;
a debit card; and
a prepaid card.

10. The system of claim 7 wherein:
the transaction card is a virtual card; and
the card reader is electromagnetic or optical.

11. A method for providing discounts to a customer, comprising the step of:
a. electronically transmitting to the processor computer of claim 1 details about discounts that a merchant wants to offer.

12. A method for providing discounts to a customer, comprising the steps of:
a. providing the customer with a transaction card that is linked to a card account;
b. providing a merchant with a card terminal programmed to obtain information about the transaction card and to transmit such information;
c. providing a processor computer;
d. providing a merchant account;
e. the merchant transferring to a servicer details about discounts that the merchant wants to offer;
f. the servicer storing the details about discounts on the processor computer;
g. the customer initiating a purchase transaction with the merchant;
h. the merchant obtaining information about the transaction card with the card terminal;
i. the card terminal sending information about the purchase transaction and the transaction card to the processor computer;
j. the processor computer analyzing the information sent from the card terminal and comparing the analyzed information with the details about discounts stored in the processor computer to determine if the purchase transaction qualifies for a discount;
k. transferring from the card account to the merchant account purchase funds equal to a purchase price of the purchase transaction without any discount; and
l. if the purchase transaction qualifies for a discount, transferring from the merchant account to the card account discount funds equal to the discount.

13. The method of claim 12
wherein:
the merchant account provided in step d) comprises a merchant settlement account and a merchant operating account;
the transfer of purchase funds from the card account in step k) is into the merchant settlement account; and
the transfer of discount funds into the card account in step l) is from the merchant operating account;
the method further comprising step:
m. settling the merchant settlement account and the merchant operating account with each other.

14. The method of claim 13 further comprising step:
n. if the purchase transaction qualifies for the discount, the processor computer electronically notifying the customer about the discount.

15. The method of claim 14 wherein the notification of step n) further comprises notifying the customer at the time of the purchase transaction that the discount will be refunded to the card account.

16. The method of claim 14 wherein the notification of step n) occurs after and within 48 hours of step l) and further comprises notifying the customer that the discount has been refunded to the card account.

17. The method of claim 14 further comprising step:
o. if the purchase transaction qualifies for the discount, prompting the customer through the card terminal whether the customer wishes to use the discount;
wherein step l) is performed only if the customer responds affirmatively to the prompt in step o).

18. The method of claim 17 wherein:
step a) further comprises providing a first financial institution comprising the card account;
step d) further comprises:
providing a payment gateway comprising the merchant settlement account; and
providing a second financial institution comprising the merchant operating account; and
step i) further comprises the card terminal sending information about the purchase transaction and the transaction card to the payment gateway, which routes the information to the processor computer.

19. The method of claim 18 wherein the transaction card provided in step a) is a member selected from the group consisting of:
a credit card;
a debit card; and
a prepaid card.

20. A method for providing discounts to a customer, comprising the steps of:
a. providing the customer with a transaction card that is linked to a card account with a first financial institution;
b. providing a merchant with a card terminal programmed to obtain information about the transaction card and to transmit such information;
c. providing a processor computer;
d. providing a payment gateway comprising a merchant settlement account;
e. providing a second financial institution comprising a merchant operating account;
f. the merchant transferring to a servicer details about discounts that the merchant wants to offer;
g. the servicer storing the details about discounts on the processor computer;
h. the customer initiating a purchase transaction with the merchant;
i. the merchant obtaining information about the transaction card with the card terminal;
j. the card terminal electronically sending information about the purchase transaction and the transaction card to the payment gateway, which electronically routes the information to the processor computer;
k. the processor computer analyzing the information sent from the card terminal and comparing the analyzed information with the details about discounts stored in the processor computer to determine if the purchase transaction qualifies for a discount;
l. prompting the customer through the card terminal as to 1) the portion of a purchase price of the purchase transaction that the customer wishes to pay using the transaction card, and 2) the portion of the purchase price of the purchase transaction that the customer wishes to pay using another payment method;
m. checking electronically whether the card account contains sufficient funds to cover the portion of the purchase price that the customer wishes to pay using the transaction card;
n. if the card account contains sufficient funds per step m):
1) electronically transferring from the card account to the merchant settlement account purchase funds equal to the portion of the purchase price that the customer wishes to pay using the transaction card; and
2) the customer paying the portion of the purchase price of the purchase transaction that the customer wishes to pay using another payment method;
o. if the card account does not contain sufficient funds per step m), the customer paying the purchase price of the purchase transaction using another payment method;
p. if the purchase transaction qualifies for a discount, electronically transferring from the merchant operating account to the card account discount funds equal to the discount;
q. if the purchase transaction qualifies for the discount, the processor computer electronically notifying the customer about the discount; and
r. electronically settling the merchant settlement account and the merchant operating account with each other.
